(19) United States
(12) Patent Application Publication
(10) Pub. No.: US 2008/0065404 A1
(43) Pub. Date: Mar. 13, 2008

(54) Method of Selecting a Hair Coloring Product at Shelf

(76) Inventors: Matthew P. Cinelli, Loveland, OH (US); Mark Andrew Komanecky, Cincinnati, OH (US); Christopher Edward Forsythe, Denver, CO (US); Amy C. Keating, Denver, CO (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/941,444

(22) Filed: Nov. 16, 2007

(51) Int. Cl. G06Q 10/00; G06Q 30/00

(52) U.S. Cl. 705/1

(57) ABSTRACT

An apparatus to assist shopper selecting a hair color product at a retail store reduces mistakes by shoppers in selecting products and increases the confidence the shopper has in selecting the correct product, and as such grows the overall sales of the hair color product category for retailers.

### FIELD OF THE INVENTION

The present invention is directed to assisting shoppers in selecting a hair coloring product while shopping at a retail store.

### BACKGROUND OF THE INVENTION

Two important purchase barriers for shoppers of hair color products in a retail store are the overwhelming number of products available to a shopper (i.e., “sea of faces”) to select from and the potential “fear factor” in making the wrong selection. Recent research by applicant suggests that about 57% of shoppers in the U.S.A. are dissatisfied with their shopping experience in the hair color aisle of a retail store. For those reasons and others, 38% of shoppers who intend to purchase hair coloring products do not do so after visiting the hair color aisle of a retail store. But of those shoppers who do purchase hair color products at a retail store, 47% report that their purchase decisions are made at the hair color shelf. In view of the foregoing, there is an opportunity to provide a better shopping experience by aiding the shopper in the de-selection of products process, encouraging regimen products, increasing the frequency of purchasing products, and/or attracting salon users to purchase hair color products at a retail store. A solution to one or more of these problems benefits the shopper by providing a more pleasant shopping experience, the retailer by growing sales of the hair color category, and the manufacturers of hair color products by providing the opportunity to sell more such products to the retailer.

See e.g., U.S. Pat. Nos. 5,316,481; 6,707,929; and 6,980,888.

### SUMMARY OF THE INVENTION

The present invention attempts to address these and other needs by providing, in a first aspect of the invention, a method of recommending one or more hair color products to a shopper in a retail store. In this aspect of the invention, a touchscreen apparatus is provided adjacent to hair color products offered for retail purchase in the retail store. The apparatus comprises displayable pages navigable by the shopper's touch. The pages are: a first page comprising of at least three different hair color purchase inspiration segments selectable by the shopper; a second page comprising of at least two different time segments selectable by the shopper, where each time segment is characteristic of the time required for the recommended hair color product to work in coloring hair; and a third page identifying one or more hair color products, where the hair color products are capable of (1) providing the hair color purchase inspiration as selected by the shopper and (2) accomplishing the hair coloring process in the time segment selected by the shopper. Without wishing to be bound by theory, this aspect of the invention may let shoppers know that there is a category of hair color products that takes a relatively short time to work (e.g., about 10 minutes). There may be a misconception by some shoppers that coloring hair at home takes a long time (e.g., about 30 minutes or longer). By educating and correcting the shopper about this potential misconception, a purchase barrier may be removed thereby allowing some shoppers to consider coloring their hair at home.

Another aspect of the invention provides for a method of recommending one or more hair color products to a shopper in a retail store. This inventive aspect comprises a touchscreen apparatus adjacent to hair color products offered for retail purchase in the retail store, where the apparatus comprises of displayable pages navigable by the shopper's touch. The pages comprise: a first page comprises of at least three different hair color purchase inspiration segments selectable by the shopper; a second page comprises of at least three different current hair color shades selectable by the shopper as the shopper's current hair color; and, a third page comprising recommendations for a plurality of desired hair color shades based upon selections made by the shopper on the first and second pages of the display apparatus. In this aspect, the desired hair color shades are selectable by the shopper. The third page of the touchscreen apparatus identifies the hair color product(s) which are capable of providing the desired hair color shade(s) as selected by the shopper given the shopper's current hair shade. Without wishing to be bound by theory, this aspect of the invention may allow shoppers to focus on the end result or inspirational benefit of their desired hair color as opposed to starting with a brand name and working backwards to identify a benefit that may (or may not even) be offered by the brand in question. In other words, the shopper is not constrained by the benefits and inspirations offered by a single brand but rather can find the product—irrespective of the brand—that best meets the shopper's desired hair color inspirations/hair color results.

In yet another aspect of the invention a method is provided for recommending one or more hair color regimen products to a shopper in a retail store. This aspect of the invention comprises of providing a touchscreen apparatus adjacent to hair color products offered for retail purchase in the retail store. The apparatus comprises displayable pages navigable by the shopper's touch. The pages of the touchscreen apparatus comprise of: a first page comprising at least three different current hair color shades selectable by the shopper as the shopper's current hair color; a second page comprising recommendations for a plurality of desired hair color shades based upon the shopper's selected current hair color shade and their desired hair color shade; a third page recommending hair color product(s) that are capable of providing the desired hair color shade as selected by the shopper; and a fourth page which recommends one or more hair color regimen products, selectable by the shopper, based upon the hair color product selected by the shopper. Without wishing to be bound by theory, this aspect of the invention may allow shoppers to quickly find those products—irrespective of the brand—that provides the product benefit for their specific desired hair color shade. For example, at the time of this application not all manufacturers of hair color products manufacture a hair color touch up product (even though some hair color touch up products from a first brand may be compatible with a hair color product by a second (different) brand). Such an approach may remove a purchase barrier since some shoppers are very sensitive to what products will work with their desired hair color shade. This aspect, therefore, may provide an opportunity for the retailer to sell more colored hair regimen products and provide to the manufacturers of hair color regimen products additional opportunities to produce and sell more products to the retail merchants.

The invention also provides for systems, and computer program products.

### DETAILED DESCRIPTION OF THE INVENTION

A hair color product is a consumer product intended to be used in coloring hair, preferably the hair on the top of a consumer's head. Generally and without limitation, success in building the hair color product category for retailers includes three elements: segmentation of the category; educating shoppers about the segments; and providing a means in the retail store for shoppers to select the appropriate hair color shade based on their desired end result.

Shoppers shopping in the hair color category at a retail store can be characterized into two groups. The first group is those shoppers that are infrequent shoppers or new users. This first group is generally not knowledgeable of the category, seeks information about the category, and may or may not already be a salon user of hair color products. This first group may also provide an opportunity to the retailer to entice these shoppers to become frequent users of at-home hair color products. The desired experience of this first group is generally one desiring not to make a mistake when purchasing a hair color product. Generally, applicant's research suggests that about 9% of the U.S.A. population is represented by this first group, but the group also represents about 23% of users and future triers of hair color products.

The second group of shoppers includes frequent users of hair color products. This second group can be further divided into non-routine buyers and routine buyers. The non-routine buyer generally likes buying new brands and likes trying new colors. The desired experience for this buyer is one where he or she wants attention drawn to new and different products or benefits as part of their shopping experience. These non-routine buyers of the second group represent about 15% of the U.S.A. population and about 40% of users and future triers of hair color products.

The routine buyers (of the second group) generally are characterized by having a regular routine and are typically loyal to a particular brand of product and color. The desired experience of these routine buyers is for the store not to be out-of-stock and for the shopper to easily find their usual product in the same place every time. The routine buyers represent about 14% of the U.S.A. population and about 37% of users and future triers of hair color products.

There is an opportunity for retailers to better organize their hair color category by segmentation. Preferably this segmentation is organized by the shopper's purchase inspiration, with brand blocks and optimized product adjacencies. Such an approach aids the shopper in de-selecting products, and encourages regimen and trade-up (for incremental sales). Non-limiting examples of product segmentation by purchase inspiration include: age defying color, rejuvenating color, healthy-looking gentle color, fashion color, special effects, and value. In one embodiment, the hair color category is segmented into 3, 4, 5, 6, 7, 8, 9, 10, 11, 12, 13, 14, 15, or more different segments in retail aisle shelving the hair color products. In another embodiment, the purchase inspiration of the shopper comprises at least “semi-permanent color.” Without wishing to be bound by theory, the “semi-permanent” segment calls to the attention of shoppers that there is a category that is not permanent. This lowers the risk for some shoppers and therefore arguably removes a purchase barrier.

Information at the shelf (e.g., signage) helps to define and inform the shopper about each segment. The information provided may also help to describe the purchase inspiration for each segment. Without wishing to be bound by theory, this segmentation information improves shoppers' confidence about the category and provides new users with a starting point. The information generally enables informed purchased decisions and as such, generally increases user satisfaction and repeat purchases. In another embodiment, each segment at the hair color aisle within the retail store comprises signage about segmentation information. Without limitation, the signage may be in the form of a banner and/or footer at shelf; a shelf talker; a vertical divider; a combination thereof; or the like.

Although segmentation and segmentation information at shelf is one part of a potentially successful hair color category solution, it may not be enough. Shoppers generally want to know how the color represented by the hair color product will look on their own hair.

Touchscreens

One aspect of the invention provides for a touchscreen apparatus in the store adjacent the hair color products being offered for retail sale. A “touchscreen apparatus” is used herein to mean any technology that is capable of displaying information to a shopper and receiving information from the shopper on the same screen. A touchscreen apparatus does not include the use of a keyboard and/or mouse as the primary means for the shopper to enter information into the apparatus. Further details of a touchscreen are provided in Wikipedia (http://en.wikipedia.org/wiki/Touchscreen).

For example, the touchscreen apparatus, as used in the context of the present invention, displays a page (wherein the page comprises text and/or graphics) on a screen. The page may provide information to the shopper and provide options for the shoppers to select. The selection effectuated by the shopper (i.e., information received from the shopper by touching (e.g., with a finger) the screen at the appropriate location) will dictate the subsequent page displayed. In other words, the shopper is able to navigate the multiple pages displayable from the apparatus based upon selections the shopper effectuates by touching the screen.

The touchscreen apparatus may be placed anywhere inside the retail store such that a shopper would reasonably appreciate that the apparatus is associated with the hair color product category. For example, the apparatus may be integral to the shelves that shelve hair color products. Alternately the apparatus may be a kiosk that is adjacent to the hair color products. Alternatively the apparatus may be placed at the end-cap of the aisle. The apparatus is preferably situated in a location and such a height that it allows shoppers (of average height etc.) touch access to the screen of the touchscreen apparatus while shopping for hair color products. In one embodiment, the apparatus comprises signage and/or a page with a message such as “find your color” to encourage shoppers to engage the apparatus.

As an additional feature, the touchscreen apparatus may also have an integral highly reflective surface or mirror located close to the screen so that the shopper may closely compare his/her hair color to the shades being presented on the apparatus pages.

Many shoppers want confidence in knowing that the recommendation of the hair color product or color shade being recommended is the correct one. Without wishing to be bound by theory, given the perceived high risk associated with choosing the wrong hair color product, shoppers generally have more confidence in a “high technology” solution verses a “low technology.” An example of a low technology solution is one involving paper (such as a paper catalogue at shelf or other such means). However, a problem with some high technology solutions, such as those involving a keyboard or a computer mouse, is that for many shoppers, it proves to be too much of technology barrier. It is observed that a touchscreen apparatus provides the level of technology that instills confidence in shoppers that the recommendations being made by the apparatus are the correct ones, and also provides the ease-of-use that enables even those shoppers that are generally intimidated by technology feel uninhibited in using the apparatus.

The touchscreen apparatus displays a plurality of pages (and combinations thereof) depending upon the touch selections made by the shopper. The present invention is directed, in part, by providing one or more of the following pages to the shopper selecting a hair color or hair color product in a retail store.

Invitation

A page may invite the shopper to engage the apparatus by offering to recommend a hair color or hair color product to the shopper, preferably within a period of time or within a prescribed number of steps. For example, the page may read: “Find your perfect color in just 30 seconds.” In another example, the page may read: “Find your perfect color in six easy steps.”

Meeting Hair Color Needs

A page may invite the shopper to select among hair color product segments, preferably segments that are characterized by purchase inspiration. The page may include language to help define the segments. The page may provide 2, 3, 4, 5, 6, 7, 8, 9, 10 or more different segments for the shopper to select. Each hair color product segment may include information about the segment.

Another page may invite the shopper to select from time segments as generally characteristic of the time the hair color products take to work in coloring hair. For example, the shopper may be invited to select between either a 10 minute color or a 20-45 minute color. The page may provide 2, 3, 4, 5, 6, 7, 8, 9, 10, or more different time segments. The page may also contain information to help define the time segments and what is characteristic of those products characterized in the respective time segments.

Hair Color Right Now

A page may ask the shopper what the shopper's hair color is currently. The page may explain that the current hair color can be either the shopper's natural shade or a color-treated shade. A non-limiting example of such an approach includes: “Choose your current shade. What is your hair color is right now? What is the natural or color-treated shade your have at this very moment?” The page may include a description as well as perhaps a visual representation of the various hair colors. For example, the hair colors represented may include: light blonde, medium blonde, dark blonde, light brown, medium brown, dark brown, strawberry blonde, light auburn, medium auburn, dark auburn, black, mostly gray. In one embodiment, 2, 3, 4, 5, 6, 7, 8, 9, 10, 11, 12, 13, 14, 15, or more different hair colors may be represented.

This page may also have an informative statement explaining that a hair's texture will not affect the desired color result. A phone number or an opportunity for more information regarding this point may also be provided.

Desired Hair Color

A page may ask the shopper for their desired shade and provide one or more recommendations based on what the shopper selected as the shopper's hair color at the moment. For example the page may state: “Choose your desired shade. These expert-recommendations are based on your current shade.” The page may reference the shopper's selected shade and then provide a description and/or visual representation of the recommended hair color shade. Non-limiting examples of recommended shades, should the shopper, for example, choose “medium brown” include: medium blonde, light auburn, light brown, medium brown, dark blonde, medium auburn, dark auburn, and dark brown. One skilled in the hair color art will know what hair color shade recommendations to recommend to the shopper based on the current hair color shade the shopper provides. The page may also include an opportunity for the shopper to learn more about why the recommendations that are recommended are best for the shopper. Without wishing to be bound by theory, providing such information or the opportunity to provide such information re-enforces the shopper's confidence in the recommendation the shopper is receiving from the apparatus of the present invention. In one embodiment, the page may recommend 1, 2, 3, 4, 5, 6, 7, 8, 9, 10, 11, 12, 13, 14, 15, or more shades depending upon the selection(s) the shopper makes.

Choosing Tone

One page may ask the shopper to select a hair tone from a plurality of tones. For example, the page may state: “Choose the tone that best complements you.” The page may also include a reference to the shade selected by the shopper (to reinforce the apparatus is still addressing the shopper specifically). The page may offer 1, 2, 3, 4, 5, 6, 7, 8, 9, 10, or more different tones. Non-limiting examples of tones may include cool, warm gold, and natural. The page may offer a description of the tone. The page may recommend a tone based upon the shopper's eye color, skin color, and the like, or a “default” if the shopper is unsure of a selection (e.g., “natural”). The page may display hair swatches or other non-hair visual representations of color tones.

Recommending a Product

One page may recommend one or more products to the shopper based upon previous selection(s) made by the shopper. The page may state: “Based on your unique choices, here are the products that are right for you.” The page may include one or more of the following: the brand name, a representative picture of the front of the product, shade number and/or color, instructions where to find the product on the shelf (e.g., “find these shades located in the age defying color or look for shades with medium brown in the name”). The page may also invite the shopper to find out how to maintain the shopper's hair and/or hair color (e.g., “Touch on your desired product to discover how to keep your color looking great”). In one embodiment, 1, 2, 3, 4, 5, 6, 7, 8, 10, 11, 12, 13, 14, 15, or more different individual products (or combination of products) are recommended.

Optimizing Hair/Hair Color

One page may recommend the use of hair regimen products designed for color treated hair. The page may state: “Extend the life of your color with these beauty essentials.” Non-limiting examples of these regimen products of a hair color touch up product (e.g., root touch-up product such as NICE'N EASY ROOT TOUCH-UP or CLAIROL NATURAL INSTINCTS SHINE HAPPY (for a boost of shine)); or a hair shampoo/conditioner designed for colored hair (e.g., color enhancing shampoo/conditioner such as PANTENE BRUNETTE EXPRESSIONS); or hair styling products compatible with colored hair (e.g., hair gels, hair mouse, hair spray, and the like). The recommendation may identify one or more products that are best compatible with the hair color product recommended. The recommendation may or may not include the same brand as the hair color product. The recommendation may also suggest the time period to use the one or more of the additional products recommended. For example, the hair color touch up product may be recommended to be used at 3 or 4 weeks. In another example, the shampoo/conditioner may be recommended to be used daily.

Miscellaneous

Of course the page(s) described may provide an opportunity to allow the shopper to navigate backwards through the logic of the pages of the touchscreen apparatus should the shopper care to revisit a selection made earlier.

Although many of the embodiments of the present invention are described as a discrete pages, it is appreciated that the content of the pages may be combined or separated and still be within the scope and spirit of the invention. Of course the sequence of the pages may be altered or other pages not described herein can be inserted, with such embodiments still within the scope of the invention. In other words, the use of the terms “1^{st} page” and “2^{nd} page” are used for convenience only and not to suggest that the pages need to be displayed as separate pages by the apparatus. Likewise, the information contained on the pages and the recommendations provided by the apparatus may be updated to reflect new product offerings and new information available within the hair color category.

Additional pages may provide additional hair color information such as highlighting new products, highlighting new shades, providing education on hair coloring techniques, etc.

A hair care product's instructions or packaging is a useful source for obtaining information about a hair color product's (or a hair color touch up product) color, time that the product takes to work in coloring hair, and the like.

Systems

Yet another aspect of the invention provides for systems and computer program products. The systems of the present invention include at least one computer-readable medium used for storing computer instructions, data, program products, and the like. A general example of a computer is described in US 2006/0010027 A1, paragraph 78. Examples of computer readable media are compact discs, hard disks, floppy disks, tape, magneto-optical disks, PROMs (EPROM, EEPROM, Flash EPROM, etc.), DRAM, SRAM, SDRAM, etc. Stored on any one or on a combination of computer readable media, the present invention includes software for controlling both the hardware of the touchscreen apparatus and for enabling the apparatus to interact with a shopper. Such software may include, but is not limited to, device drivers, operating systems and user applications. Likewise, the apparatus can include input and output provisions to easily update the software controlling the hardware, the shopper interactive systems and enabling for the collection of consumer input data for further research.

In one embodiment, the retailer or retail store is a large retailer (verses a salon or boutique) such as WAL-MART, TARGET, KROGERS, CVS, WALGREENS, COSTCO, SAMS CLUB, and the like.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of recommending one or more hair color products to a shopper in a retail store comprising providing a touchscreen apparatus adjacent to hair color products offered for retail purchase in the retail store, wherein the apparatus comprises displaying pages navigable by touch by the shopper, and wherein the pages comprise:
(a) a first page comprising at least three different hair color purchase inspiration segments selectable by the shopper;
(b) a second page comprising at least two different time segments selectable by the shopper, wherein each time segment is characteristic of the time the hair color product takes to work in coloring hair;
(c) a hair color product page comprising identifying one or more hair color products, wherein the hair color products provide the purchase inspiration selected by the shopper; and wherein the product(s) are characteristic of the time the hair color products takes to work in coloring hair as selected by the shopper.

2. The method according to claim 1 further comprising:
(a) a third page comprising at least three different hair current color shades selectable by the shopper as the shopper's current hair color;
(b) a fourth page comprising recommending a plurality of desired hair color shades based upon selections made by shopper to at least the first, second, and third pages, wherein the desired hair color shades are selectable by the shopper;
(c) the hair color product page further comprises identifying hair color products that provide the recommended desired hair color shade as selected by the shopper.

3. The method according to claim 2, wherein each segment, of at least three hair color purchase inspiration segments, is each chosen from: age-defying color, healthy-looking gentle color, semi-permanent color, fashion color, or a combination thereof.

4. The method according to claim 2, wherein a first time duration segment comprises “10-minutes.”

5. The method according to claim 3, wherein a first time duration segment comprises “10-minutes.”

6. The method of claim 2, wherein identifying the hair color product further comprises providing instructions where to find the recommended hair color product on the shelf.

7. A method of recommending one or more hair color products to a shopper in a retail store comprising providing a touchscreen apparatus adjacent to hair color products offered for retail purchase in the retail store, wherein the apparatus comprises displaying pages navigable by touch by the shopper, and wherein the pages comprise:
(a) a first page comprising at least three different hair color purchase inspiration segments selectable by the shopper;
(b) a second page comprising at least three different hair current color shades selectable by the shopper as the shopper's current hair color;
(c) a third page comprising recommending a plurality of desired hair color shades based upon selections made by shopper to at least the first and second pages, wherein the desired hair color shades are selectable by the shopper;
(d) a hair color product page comprising identifying the hair color product, wherein the hair color product provides:
(i) the purchase inspiration as selected by the shopper; and
(ii) providing the recommended desired hair color shade as selected by the shopper.

8. The method according to claim 7, wherein each segment of the at least three hair color purchase inspiration segments is each chosen from: age-defying color, healthy-looking gentle color, semi-permanent color, fashion color, or a combination thereof.

9. The method according to claim 7, wherein at least one segment, of the at least three color purchase inspiration segments, comprises semi-permanent color.

10. The method according to claim 7, wherein a first time duration segment comprises “10-minutes.”

11. The method according to claim 8, wherein a first time duration segment comprises “10-minutes.”

12. The method of claim 8, wherein identifying the hair color product further comprises providing instructions where to find the recommended hair color product on the shelf.

13. A method of recommending one or more hair color regimen products to a shopper in a retail store comprising providing a touchscreen apparatus adjacent to hair color products offered for retail purchase in the retail store, wherein the apparatus comprises displaying pages navigable by touch by the shopper, and wherein the pages comprise:
(a) a first page comprising at least three different current hair color shades selectable by the shopper as the shopper's current hair color;
(b) a second page comprising recommending a plurality of desired hair color shades based upon the shopper selected current hair color shade, wherein the desired hair color shades are selectable by the shopper;
(c) a hair color product page comprising identifying the one or more hair color products selectable by the shopper, wherein each of the identified hair color product(s) are capable of providing the recommended desired hair color shade as selected by the shopper;
(d) a hair color regimen page comprising identifying one or more hair color regimen products, selectable by the shopper, based upon the hair color product selected by the shopper.

14. The method of claim 13, wherein the hair color regimen product comprises a hair color touch-up product.

15. The method of claim 13, wherein the hair color regimen product comprises a hair shampoo or a hair conditioner, wherein the shampoo and conditioner are designed for hair color treated hair.

16. The method of claim 14, wherein the hair color regimen product further comprises a hair shampoo or a hair conditioner, wherein the shampoo and conditioner are designed for hair color treated hair.

17. The method of claim 13, further comprising a third page comprising at least three different hair color purchase inspiration segments selectable by the shopper; and wherein the hair color product page further comprises identifying hair color products that are capable of providing the recommended desired hair color shade as selected by the shopper.

18. The method of claim 13, further comprising a fourth page comprising at least two different time segments selectable by the shopper, wherein each time segment is characteristic of the time the hair color product takes to work in coloring hair; and wherein the hair color product page comprising identifying the hair color product(s) that comprises the characteristic of the time the product(s) take to work in coloring hair as selected by the shopper.

19. The method of claim 17, further comprising a fourth page comprising at least two different time segments selectable by the shopper, wherein each time segment is characteristic of the time the hair color product takes to work in coloring hair; and wherein the hair color product page comprising identifying the hair color product(s) that comprises the characteristic of the time the product(s) take to work in coloring hair as selected by the shopper.

20. The method of claim 19, wherein the hair color regimen product is chosen from a hair shampoo or a hair conditioner or a hair color touch-up product, wherein the shampoo and conditioner are designed for hair color treated hair.
